(19) United States
(12) Patent Application Publication
(10) Pub. No.: US 2012/0094227 A1
(43) Pub. Date: Apr. 19, 2012

(54) TONER FOR DEVELOPING ELECTROSTATIC LATENT IMAGE

(75) Inventors: Shinya OBARA, Tokyo (JP); Masahiro ANNO, Osaka (JP); Satoshi UCHINO, Tokyo (JP); Hidehito HARUKI, Tokyo (JP)

(73) Assignee: KONICA MINOLTA BUSINESS TECHNOLOGIES, INC., Tokyo (JP)

(21) Appl. No.: 13/271,083

(22) Filed: Oct. 11, 2011

(30) Foreign Application Priority Data
Oct. 14, 2010 (JP) JP2010-231295

(51) Int. Cl. G03G 9/08

(52) U.S. Cl. 430/109.1

(57) ABSTRACT

A toner for developing an electrostatic latent image is disclosed, the toner being composed of toner particles which comprises toner mother particles containing a binding resin having a hydrophilic polar group, a coloring agent and a releasing agent, and an external additive, wherein a mass of Na atoms in a neighborhood of surface of the toner particles measured by the measuring method described below is 50 to 750μg in 1 g of toner particles.

Measuring Method
(a) Extracting Na atoms in the neighborhood of surface of the toner particles by stirring the toner particles and dilute hydrochloric acid,
(b) Preparing sample for measurement by filtering the liquid extracting Na atoms, and
(c) Measuring the mass of Na atoms in the sample via Induction Coupling Plasma Optical Emission Spectrometer.

This application is based on Japanese Patent Application No. 2010-231295 filed on Oct. 14, 2010, in Japanese Patent Office, the entire content of which is hereby incorporated by reference.

### TECHNICAL FIELD

The present invention relates to a toner for developing an electrostatic latent image.

### BACKGROUND OF THE INVENTION

Opportunity to use a printer or a multi-function printer utilizing an electrophotography in the production print market further to office works is increasing in recent years. Desire to obtain always printed matter having high image quality continuously even when printing environment varies is rising in the production print market.

Toner manufactured by a wet method in which resin particles and a coloring agent are subjected to coagulation and fusion in an aqueous medium is used to satisfy the desire to obtain high image quality printed matters.

A surfactant is used to disperse a coloring agent and obtained toner mother particles in aqueous medium stably in a process of manufacturing resin particles or in a step of coagulation and fusion of resin particles and a coloring agent in an aqueous medium or a step of resin particles in this toner manufacturing method.

The toner obtained by this manufacturing method has such advantage that the toner is excellent in uniform particle size distribution, as well as, control of diameter of toner particles is easy and the method is suitable for realizing small size particles.

Further charging property depends on environment in the toner obtained by wet method using a binding resin having a hydrophilic polar group. For the countermeasure a technology to control number percent of alkali metal or alkali earth metal by surface analysis via ESCA is 0.8% or more by bonding alkali metal or alkali earth metal to a hydrophilic polar group at surface of the toner particles is disclosed (see, for example, Patent Document 1).

However this method could not be applied to small size particle toner which requires high charging since alkali metal or alkali earth metal is allowed to exist at surface of the toner particles in certain level and charge quantity of toner lowers.

Further, a toner in which a hydrophilic polar group exists at a surface of the toner particles, amount of alkali metal surface of the toner particles measured via ESCA is 0.7% or less based on the total amount of carbon and oxygen, and ratio of charge quantity CGS′ at low temperature and low humidity environment to charge quantity CGS″ high temperature and high moisture environment CGS′/CGS″ is 0.30 or more as well as CGS″ satisfies the following inequality, and its manufacture method are disclosed (see, for example, Patent Document 2).

CGS″≧−3.0×(quantity ratio % of alkali metal)+4.5

### PATENT DOCUMENT

Patent Document 1: JP-A H09-114125
Patent Document 2: JP-A 2001-255700

### SUMMARY OF THE INVENTION

However in the toner manufactured by the technologies described above there are problems such that charge quantity cannot be maintained stably in printing environment at high temperature and high moisture, image density varies, printed matters with high image density cannot be obtained, a sandy image is generated in the print image or toner scatters and cause stain within a printer when plenty sheets are printed in a printing environment at high temperature and high moisture.

An object of this invention is to provide a toner for developing an electrostatic latent image in which charge quantity is maintained stably in a printing environment of high temperature and high moisture (for example, 30° C., 80% RH), variation of image density is minimized, printed matter with high density is obtained, the printed image has no sandy image, the toner does not scatter and cause stain within the apparatus when plenty sheets are printed in a printing environment of high temperature and high moisture.

The present invention is described.

The toner for developing an electrostatic latent image composed of toner particles which comprises toner mother particles containing a binding resin having a hydrophilic polar group, a coloring agent and a releasing agent and an external additive, wherein a mass of Na atoms in the neighborhood of surface of the toner particles measured by the measuring method described below is 50 to 750 μg in 1 g of toner particles.

### Measuring Method

(a) Extracting Na atoms in the neighborhood of surface of the toner particles by stirring the toner particles and dilute hydrochloric acid,

(b) Preparing sample for measurement by filtering the liquid extracting Na atoms, and

(c) Measuring the mass of Na atoms in the sample via Induction Coupling Plasma Optical Emission Spectrometer.

The hydrophilic polar group is preferably a carboxyl group.

The toner of this invention can maintain charge quantity stably in a printing environment at high temperature and high moisture, and has excellent advantages such that high quality image having high density, no rough image, and less variation of image density is formed and stains inside of the apparatus by toner scattering is not generated in case of a plenty printing in an environment at high temperature and high moisture.

### BRIEF DESCRIPTION OF THE DRAWINGS

FIG. 1 shows an example of an image forming apparatus in which the toner of this invention may be used.

### EMBODIMENTS

It is necessary to maintain charge quantity of the toner in respective printing environment or time lapsing to obtain a high quality image constantly.

Toner is charged by friction with carrier. The charge quantity changes greatly depending on a species of a binding resin, composition of surface of the toner particles and a functional group, as shown by electronegativity or charging order. Though the mechanism of the frictional charging has not made clear, it is assumed that state of surface of the toner particles is significant.

Charging property in high temperature and high moisture environment is problematic to maintain the toner charge quantity stably. A toner having a hydrophilic polar group in a neighborhood of surface of the toner particles is difficult to maintain the charge quantity stably due to influence of water since water in the air forms hydrogen bond to a hydrophilic polar group.

When charge quantity changes by influence of water, such problems occurs that image density of the print varies, image becomes rough or toner scatters inside of the printer.

The inventor considered and studied that affinity of the hydrophilic polar group to water can be reduced by bonding the hydrophilic polar group in a neighborhood of surface of the toner particles to Na ion, whereby charge quantity can be maintained stably in high temperature and high moisture environment.

The object of the invention can be attained by employing a toner having specific mass of Na atoms in the neighborhood of surface of the toner particles which is obtained by adding an external additive to toner mother particles containing a binding resin having a hydrophilic polar group, a coloring agent and a releasing agent.

The embodiments of the invention are described.

<Toner>

The toner comprises toner mother particles containing a binding resin having a hydrophilic polar group, a coloring agent and a releasing agent, and an external additive.

Toner is composed of toner particles, and the toner particles are obtained by adding an external additive to the toner mother particles.

<Mass of Na Atoms in Neighborhood of Surface of Toner Particles>

The mass of Na atoms in the neighborhood of surface of the toner particles is 50 to 750 μg in 1 g of toner particles, preferably 200 to 650 μg in 1 g of toner particles.

When mass of Na atoms in the neighborhood of surface of the toner particles is 50 μg in 1 g of toner particles or more, high charge quantity can be kept stably in high temperature and high moisture condition, variation of image density is minimized, occurring rough image and toner scattering are prevented. When mass of Na atoms in the neighborhood of surface of the toner particles is 750 μg in 1 g of toner particles or less, fluidity of the toner is kept and occurring rough image and toner scattering are prevented in high temperature and high moisture condition.

(Measurement of Mass of Na Atoms in the Neighborhood of Surface of the Toner Particles)

Mass of Na atoms in the neighborhood of surface of the toner particles can be obtained by extracting Na atoms in the neighborhood of surface of the toner particles with dilute hydrochloric acid, and measuring the extract liquid via Induction Coupling Plasma Optical Emission Spectrometer.

Induction Coupling Plasma Optical Emission Spectrometry is a method spectrally analyzing light emitted when metal element or the like is excited, and qualitative analysis and quantitative analysis are conducted by wavelength specific to each element and emission strength, respectively.

The neighborhood of surface of the toner particles is an area extracted by dilute hydrochloric acid when dilute hydrochloric acid and toner are stirred at predetermined temperature for predetermined time.

Specifically, 1 g of toner is charged in 100 ml of beaker, 50 ml of 0.01N hydrochloric acid at 20° C. is added as extracting liquid of Na atoms, and Na atoms are extracted by stirring by a magnet stirrer at 100 rpm for 15 minutes. Toner is removed from the extract liquid, then extract liquid is injected into Induction Coupling Plasma Optical Emission Spectrometer (ICP-AES) ‘SPS3520UV’ (product by SII NanoTechnology Inc.), quantitative analysis of Na atoms is conducted.

<Mass of Na Atoms in Toner Particles>

The mass of Na atoms in the toner particles is preferably 400 to 1,500 μg in 1 g of toner particles, and more preferably 500 to 1,300 μg in 1 g of toner particles.

(Measurement of Mass of Na Atoms in the Toner Particles)

Mass of Na atoms in the toner particles can be measured via Induction Coupling Plasma Optical Emission Spectrometry.

Specifically, 100 mg of toner is decomposed by adding 4 ml of sulfuric acid and 4ml of nitric acid employing sealed type microwave decomposition apparatus, ETHOS One product by Milestone General K.K.

### Decomposition Condition

TimeTemperature

| | |
|---|---|
| 3 minutes | 85° C. |
| 2 minutes | 45° C. |
| 5 minutes | 140° C. |
| 25 minutes | 230° C. |
| 20 minutes | 230° C. |

Thereafter, determination is conducted via ICP-AES ‘SPS3520UV’, product by SII NanoTechnology Inc.

<Binding Resin>

A binding resin used in this invention is a resin having a hydrophilic polar group.

The hydrophilic polar group is preferably a carboxyl group.

Content ratio of the hydrophilic polar group to binding resin is preferably 3 to 25 mass % by mass, more preferably 10 to 20 mass % by mass in terms of ratio of mass polymerizable monomer having a hydrophilic polar group to mass of total polymerizable monomers composing the binding resin.

<Production Method of Toner>

Toner of this invention is preferably produced by an emulsification coagulation method. The production method coagulating resin particles composed of multi-step polymerization by mini-emulsion polymerization is particularly preferable.

Example of a toner production method by mini-emulsion polymerization coagulation method is described in detail. Toner is produced by the following steps.

(1) Dissolution/dispersion step in which a releasing agent, a coloring agent and optionally, a charge control agent are dissolved or dispersed in a polymerizable monomer to form a binder resin to obtain a polymerizable monomer solution,

(2) polymerization step in which the polymerizable monomer solution is dispersed in the form of oil-droplets dispersed in an aqueous medium and polymerized by mini-emulsion polymerization to prepare a dispersion of resin particles,

(3) coagulation/fusion step in which the resin particles are allowed to be salted out, coagulated and fused to form coagulated particles,

(4) ripening step in which the coagulated particles are thermally ripened to control the particle form to obtain a dispersion of toner mother particles,

(5) cooling step in which the toner mother particle dispersion is cooled,

(6) supplying Na atoms and washing step in which toner mother particles are separated through solid/liquid separation from the cooled toner mother particle dispersion, thereafter, Na atom is supplied to the toner mother particles re-dispersed in warm water, and the resultant is washed with water.

(7) drying step in which the washed toner mother particles are dried, and

(8) a step of adding external additives to the dried toner mother particles (external addition treatment).

Each step is described.

### (1) Dissolution/Dispersion Step

This step comprises dissolving or dispersing releasing agents in a polymerizable monomer to form a polymerizable monomer solution.

### (2) Polymerization Step

In one suitable embodiment of the polymerization step, the foregoing polymerizable monomer solution is added to an aqueous medium containing a surfactant and mechanical energy is applied thereto to form oil-droplets, subsequently, polymerization is performed in the interior of the oil-droplets by radicals produced from a water-soluble polymerization initiator. Resin particles as nucleus particles may be added to the aqueous medium in advance.

Resin particles containing reducing agents and a binder resin are obtained in the polymerization step. The obtained resin particles may or may not be colored. The colored resin particles can be obtained by subjecting a monomer composition containing a coloring agent to polymerization. In cases when using non-colored resin particles, a dispersion of coloring agent particles is added to a dispersion of resin particles, and the coloring agent particles and the resin particles are coagulated to obtain coagulated particles.

### (3) Coagulation Step

In the coagulation step coagulated particles are formed by coagulating resin particles (colored or non-colored resin particles) obtained in the polymerization step and a coloring agent added as required in dispersion liquid. In the coagulation step, particles of internal additives such as a charge control agent and releasing agent particles may be coagulated together with resin particles and coloring agent particles.

Dispersion liquid of the coloring agent is prepared by dispersing the coloring agent in an aqueous medium. Dispersing machines used for dispersing the coloring agent are not specifically limited but preferred examples thereof include pressure dispersing machines such as an ultrasonic disperser, a mechanical homogenizer, a Manton-Gaurin homomixer or a pressure homogenizer, and a medium type dispersing machines such as a sand grinder, a Getzman mill or a diamond fine mill.

A coloring agent may be subjected to surface modification treatment. The surface modification treatment of the coloring agent is conducted by dispersing the coloring agent, adding a surface modification agent in the dispersion liquid, then, reacting these by raising temperature. After completion of reaction, a coloring agent is removed by filtration,

A coloring agent treated with the surface modification agent is obtained by repeating washing and filtering with same solvent.

A preferable method of coagulation includes steps adding coagulation agent composed of an alkali metal salt or an alkali earth metal salt into aqueous liquid containing resin particles and a coloring agent, thereafter conducting coagulation and fusion at a temperature higher than glass transition point of the resin particles, and the coagulated particles are obtained.

### (4) Ripening Step

This is a step to obtain dispersion liquid toner mother particles by adjusting shape of coagulated particles so as to have intended circularity by heating with stirring the liquid containing coagulated particles. Heating temperature, a stirring speed and a heating time during heating with stirring are controlled in this step.

### (5) Cooling Step

This is a step to cool the dispersion liquid containing toner mother particles. Cooling is performed in a condition at a cooling rate of 1 to 20° C./min. The cooling treatment is not specifically limited and examples thereof include a method in which a refrigerant is introduced from the exterior of the reaction vessel to perform cooling and a method in which chilled water is directly supplied to the reaction system to perform cooling.

### (6) Supplying Na Atoms and Washing Step

The supplying Na atoms and washing step includes,
1. Preparing toner cake, which is gathered material like a cake of coagulated toner mother particles from a wet state, by separating toner mother particles from the liquid dispersion of toner mother particles cooled to predetermined temperature by the above described steps,
2. Preparing re-dispersed liquid by dispersing the toner cake again in ion-exchanged water at 40° C.,
3. Controlling the re-dispersed liquid in alkali state by adding NaOH aqueous solution,
4. Supplying Na atoms to toner mother particles by adding NaCl aqueous solution to the alkaline re-dispersed liquid,
5. Producing toner cake by solid-liquid separation of the re-dispersed liquid again,
6. Washing the toner cake to remove surfactant and the like. In this step, washing is conducted until the filtrate reaches a conductivity of 10 μS/cm by ion-exchanged water.
7. Producing toner cake again by solid-liquid separation of dispersion liquid as subjected to washing.

A filtration treatment is conducted, for example, by a centrifugal separation, filtration under reduced pressure using a Buchner's funnel or filtration using a filter press, but the treatment is not specifically limited.

Mass of Na atoms in the neighborhood of surface of the toner particles can be controlled by adjusting pH of NaOH aqueous solution to be added or quantity of NaCl added thereafter. Surfactants are removed sufficiently from the toner mother particles by washing until the filtrate reaches a conductivity of 10 μS/cm.

### (7) Drying Step:

This step is to obtain dried toner mother particles by subjecting drying treatment to washing treated toner cake. Drying machines usable in this step include, for example, a spray dryer, a vacuum freeze-drying machine, or a vacuum dryer. Preferably used are a standing plate type dryer, a movable plate type dryer, a fluidized-bed dryer, a rotary dryer or a stirring dryer. The moisture content of the dried toner mother particles is preferably not more than 3% by mass, and more preferably not more than 1% by mass.

When the toner mother particles subjected to drying treatment form coagulate by weak attracting force between particles, the coagulate may be subjected to shredding treatment. A mechanical type of shredder such as jet mill, Henschel mixer, a coffee mill and a food processor may be used as the shredder.

### (8) External Additive Addition Step:

In this step, the dried toner mother particles are mixed with external additives to prepare a toner.

There are usable mechanical mixers such as a Henschel mixer and a coffee mill.

Materials used in the toner such as a binding resin, a surfactant, a polymerization initiator, a chain transfer agent and a coloring agent are described.

Binding Resin

The binding resin used in the toner is a binding resin having a hydrophilic polar group as described above. The hydrophilic polar group is preferably a carboxyl group.

The binding resin having a hydrophilic polar group is preferably manufactured by employing at least a polymerizable monomer having a carboxyl group.

When the toner mother particles composing the toner is manufactured by mini-emulsion polymerization coagulation method, emulsion polymerization coagulation method and the like, it is prefer to use hydrophilic polar group having ionic dissociation group as a polymerizable monomer to obtain a binding resin composing toner particles.

Polymerizable monomers having an ionic dissociation group are those having a substituent such as a carboxyl group, a sulfonate group or a phosphate group as a constituting group. Examples thereof include acrylic acid, methacrylic acid, maleic acid, itaconic acid, cinnamic acid, fumaric acid, maleic acid monoalkylester, itaconic acid monoalkyl ester, styrene sulfonic acid, allylsulfo citric acid, 2-acrylamide-2-methylpropane sulfonic acid, acid phosphooxyethyl methacrylate and 3-chloro-2-acid phosphoxypropyl methacrylate.

The polymerizable monomer having a carboxyl group is preferably among these.

The other examples of polymerizable monomer include;

styrene and styrene derivatives such as styrene, o-methylstyrene, m-methylstyrene, p-methylstyrene, α-methylstyrene, p-phenylstyrene, p-ethylstyrene, 2,4-dimethylstyrene, p-tert-butylstyrene, p-n-hexylstyrene, p-n-octylstyrene, p-n-nonylstyrene, p-n-decylstyrene and p-n-dodecylstyrene;

methacryl acid ester derivatives such as methyl methacrylate, ethyl methacrylate, n-butyl methacrylate, isopropyl methacrylate, isobutyl methacrylate, t-butyl methacrylate, n-octyl methacrylate, 2-ethylhexyl methacrylate, stearyl methacrylate, lauryl methacrylate, phenyl methacrylate, diethylaminoethyl methacrylate and dimethylaminoethyl methacrylate;

acrylic acid ester derivatives such as methyl acrylate, ethyl acrylate, isopropyl acrylate, n-butyl acrylate, t-butyl acrylate, isobutyl acrylate, n-octyl acrylate, 2-ethylhexyl acrylate, stearyl acrylate, lauryl acrylate and phenyl acrylate;

olefins such as ethylene, propylene and isobutylene;

vinyl halogenides such as vinyl chloride, vinylidene chloride, vinyl bromide, vinyl fluoride and vinylidene fluoride;

vinyl esters such as vinyl propionate, vinyl acetate and vinyl benzoate;

vinyl ethers such as vinyl methyl ether and vinyl ethyl ether;

vinyl ketones such as vinyl methyl ketone, vinyl ethyl ketone and vinyl hexyl ketone;

N-vinyl compounds such as N-vinyl compounds such as N-vinylcarbazole, N-vinylindole and N-vinylpyrrolidone;

vinyl compounds such as vinylnaphthalene and vinylpyridine; and

acrylic acid or methacrylic acid derivatives such as acrylonitrile, methacrylonitrile and acrylamide.

These vinyl based monomer are usable singly or in combination with at least two kinds.

A binding resin having a crosslinking structure can also prepare by using poly-functional vinyl compounds. Examples thereof include divinylbenzene, ethylene glycol dimethacrylate, ethylene glycol diacrylate, diethylene glycol dimethacrylate, diethylene glycol diacrylate, triethylene glycol dimethacrylate, triethylene glycol diacrylate, neopentylene glycol dimethacrylate, and neopentylene glycol diacrylate

Releasing Agent

A releasing agent used in the toner includes a polyolefin wax such as polypropylene wax, polyethylene wax. Wax having a conventional name of paraffin wax, Fischer-Tropsch wax, microcrystalline wax, metallocene wax is preferable. Other examples include aliphatic acid wax having 12 to 24 carbon atoms, and ester compound thereof, higher alcohol wax, lanolin wax, carnauba wax, rice wax, bee wax, scale insect wax and montan wax.

Surfactant

In manufacturing the toner mother particles by the suspension polymerization method, a mini-emulsion polymerization coagulation method or emulsion polymerization coagulation method, surfactants used for obtaining a binder resin include ionic surfactants described below are suitable. Such ionic surfactants include sulfonates (e.g., sodium dodecylbenzene sulfonate and sodium arylalkylpolyether sulfonate), sulfates (e.g., sodium dodecyl sulfate, sodium tetradecyl sulfate, sodium pentadecyl sulfate and sodium octyl sulfate), and ester of fatty acid (e.g., sodium oleate, sodium laurate, sodium caprate, sodium caprylate, sodium caproate, potassium stearate and calcium oleate). Nonionic surfactants are also usable. Examples thereof include polyethylene oxide, polypropylene oxide, a combination of polypropylene oxide and polyethylene oxide, an ester of polyethylene glycol and a higher fatty acid, alkylphenol polyethylene oxide, an ester of polypropylene oxide and a higher fatty acid and sorbitan ester. These surfactants are used as an emulsifying agent when manufacturing the toner by an emulsion polymerization method but may also be used in other processes or for other purposes.

Polymerization Initiator

In manufacturing the toner mother particles by a mini-emulsion polymerization coagulation method or an emulsion polymerization coagulation method, binder resin can be obtained through polymerization by using radical polymerization initiators.

Water-soluble radical polymerization initiators are usable in a mini-emulsion polymerization coagulation method or an emulsion polymerization coagulation method. Examples of a water-soluble polymerization initiator include persulfates such as potassium persulfate and ammonium persulfate; azobisaminodipropane acetic acid salt, azobiscyanovaleric acid and its salt, and hydrogen peroxide.

Chain Transfer Agent

In manufacturing the toner mother particles of the present invention by the suspension polymerization method, a mini-emulsion polymerization coagulation method or an emulsion polymerization coagulation method, generally used chain transfer agents are usable for the purpose of controlling the molecular weight of a binder resin.

Examples of the chain transfer agents include mercaptans such as n-octylmercaptan, n-decylmercaptan and tert-dodecylmercaptan; n-octyl-3-mercaptopropionic acid ester, terpinolene, carbon tetrabromide and a-methylstyrene dimmer.

Coloring Agent

Inorganic or organic coloring agent can be used in the toner. Examples of the coloring agents are listed.

The coloring agent for black toner includes for example, carbon black such as furnace black, channel black, acetylene black thermal black and lamp black, and magnetic material such as magnetite and ferrite.

Magenta or red coloring agent includes C.I. Pigment Red 2, C.I. Pigment Red 3, C.I. Pigment Red 5, C.I. Pigment Red 6, C.I. Pigment Red 7, C.I. Pigment Red 15, C.I. Pigment Red 16, C.I. Pigment Red 48;1, C.I. Pigment Red 53;1, C.I. Pigment Red 57;1, C.I. Pigment Red 122, C.I. Pigment Red 123, C.I. Pigment Red 139, C.I. Pigment Red 144, C.I. Pigment Red 149, C.I. Pigment Red 166, C.I. Pigment Red 177, C.I. Pigment Red 178 and C.I. Pigment Red 222.

Orange or yellow coloring agent includes C.I. Pigment Orange 31, C.I. Pigment Orange 43, C.I. Pigment Yellow 12, C.I. Pigment Yellow 13, C.I. Pigment Yellow 14, C.I. Pigment Yellow 15, C.I. Pigment Yellow 74, C.I. Pigment Yellow 93, C.I. Pigment Yellow 94 and C.I. Pigment Yellow 138.

Green or cyan coloring agent includes C.I. Pigment Blue 15, C.I. Pigment Blue 15;2, C.I. Pigment Blue 15;3, C.I. Pigment Blue 15;4, C.I. Pigment Blue 16, C.I. Pigment Blue 60, C.I. Pigment Blue 62, C.I. Pigment Blue 66 and C.I. Pigment Green 7.

The coloring agents listed above can be used singly or two or more kinds in combination.

Content amount of the coloring agent is 1 to 30% by mass, preferably 2 to 20% by mass based on the total mass of the toner.

Surface modified coloring agent may be used. The surface modification agents such as includes silane coupling agent, titanium coupling agent and aluminum coupling agent may be used preferably.

Coagulation Agent

Coagulants usable in manufacturing the toner mother particles by a mini-emulsion polymerization coagulation method or an emulsion polymerization coagulation method include, for example, alkali metal salts and alkaline earth metal salts. Alkali metals used as a coagulant include, for example, lithium, sodium and potassium; alkaline earth metals used as a coagulant include, for example, magnesium, calcium, strontium and barium. Potassium, sodium, magnesium, calcium and barium are preferred among these. Counter-ions for the alkali metal or the alkaline earth metal (an anion forming a salt) include, for example, chloride ion, bromide ion, iodide ion, carbonate ion and sulfate ion.

Charge Control Agent

The toner particles may optionally contain a charge control agent. Various charge control agents may be usable.

External Additive

External additives may be added to the toner to improve fluidity or charging property or to enhance cleaning capability, of the present invention. A variety of inorganic particles, organic particles and lubricants are usable as an external additive.

Inorganic oxide particles of silica, titania, alumina and the like are preferably used for inorganic particles. The inorganic particles may be surface-treated preferably by using a silane coupling agent, titanium coupling agent and the like to enhance hydrophobicity. Spherical organic particles having an average primary particle diameter of 10 to 2,000 nm are also usable. Polystyrene, polymethyl methacrylate, styrene-methyl methacrylate copolymer and the like are usable as organic particles. External additives may be used in combination of with varieties of other additives.

External additives are incorporated to the toner preferably in an amount of 0.1 to 5.0% by mass, and more preferably 0.5 to 4.0% by mass based on the total mass of the toner.

Property of toner is described.

Particle Diameter of Toner

The toner particles preferably have a volume base median particle diameter (D₅₀) of 3.0 to 8.0 μm. In manufacturing toner particles by the polymerization methods described earlier, the particle diameter can be controlled by a coagulant concentration, the addition amount of organic solvents, a fusing time and polymer composition.

A volume base median particle diameter (D₅₀) falling within the range of 3.0 to 8.0 μm achieves realizing high image quality and reproduction of fine lines as well as reducing toner consumption, compared to the use of a toner of a larger particle diameter. The volume base median particle diameter (D₅₀) can be measured via Multisizer 3, product by Beckman Coulter Inc.

Average Circularity of Toner Particle

The toner particles preferably have an average circularity of 0.930 to 1.000, and more preferably of 0.950 to 0.995 represented by the following Formula (3) in view of improvement of transfer efficiency. The average circularity can be measured by employing FPIA-2100, product by Sysmex Corp.

Average circularity={(circumference of a circle having an area equivalent to the projected area of a particle)/(a circumference of the projected particle)} Formula (3):

A developer, an image forming method and image forming apparatus in which the toner of this invention is used are described.

Developer

The toner may be used as a magnetic or nonmagnetic single component developer, or as a double component developer by mixing with a carrier. In case the toner is used as a single component developer, it is used as a non-magnetic single component developer as itself, or a magnetic single component developer prepared by mixing with magnetic particles of around 0.1 to 0.5 μm, both are useful. Carrier which is used for the double component developer includes magnetic particles of a metal such as iron, ferrite, magnetite or their alloy with a metal such as aluminum. Ferrite is particularly preferable. There may also be used a coat carrier of resin-coated magnetic particles and a resin dispersion type carrier in which a fine-powdery magnetic material is dispersed in a binder resin.

Coating resins used for the coat carrier are not specifically limited, and examples thereof include olefin resin, styrene resin, styrene-acryl resin, silicone resin, ester resin and fluorine-containing polymer resin. Resins used for the resin dispersion type carrier are not specifically limited and commonly known ones are usable, such as styrene-acryl resin, polyester resin, fluororesin and phenol resin.

A coat carrier coated with styrene-acryl resin is cited as a preferred carrier in view of preventing external additives from being released and durability.

The volume average diameter of carrier particles is preferably 20 to 100 μm, and more preferably 25 to 80 μm. The volume average diameter of the carrier particles can be determined using a laser diffraction type particle diameter distribution measurement apparatus provided with a wet disperser, HELOS (product by SYMPATEC Corp.).

Image Forming Method and Image Forming Apparatus

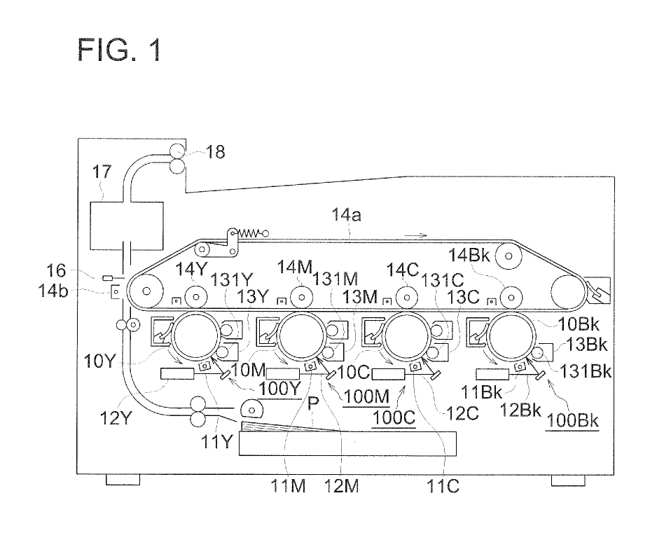

FIG. 1 shows an example of image forming apparatus used for the image forming method by the toner of the invention.

The image forming apparatus is a tandem type color image forming apparatus having four image forming units 100Y, 100M, 100C, 100Bk provided along with intermediate transfer belt 14a.

Each of image forming units 100Y, 100M, 100C, and 100Bk is formed in such a manner that a photoconductor layer composed of a conductive material and an organic photosensitive compound are formed on the outer circumference of a cylindrical substrate, and is driven by power from a driving source (not shown) or via intermediate belt 14a. Further, each unit is composed of photoreceptor drums 10Y, 10M, 10C, and 10Bk which rotate counterclockwise while the conductive layer is grounded, charging member 11Y, 11M, 11C, and 11Bk which are arranged in the right angles to the moving direction of photoreceptor drum 10Y, 10M, 10C, and 10Bk, and provide uniform potential on the surface of the above photoreceptor drums 10Y, 10M, 10C, and 10Bk, exposure member 12Y, 12M, 12C, and 12Bk which form latent images via image exposure onto the surface of uniformly charged photoreceptors 10Y, 10M, 10C, and 10Bk in such a manner that scanning is carried out in parallel to the rotation axis of each of photoreceptor drums 10Y, 10M, 10C, and 10Bk employing, for example, a polygonal mirror, rotating development sleeves 131Y, 131M, 131C, and 131Bk, and development member 13Y, 13M, 13C, and 13Bk which convey each of the retained toners to the surface of photoreceptor drums 10Y, 10M, 10C, and 10Bk.

Herein, yellow toner images are formed via image forming unit 100Y, magenta toner images are formed via image forming unit 100M, and cyan toner images are formed via image forming unit 100C, while black toner images are formed via image forming unit 100Bk.

In the above image forming apparatus, each of the color toner images formed on each of photoreceptor drums 10Y, 10M, 10C, and 10Bk of each of image forming unit 100Y, 100M, 100C, and 100Bk is sequentially transferred and superimposed onto transfer medium P which is synchronously conveyed via transfer member 14Y, 14M, 14C, and 14Bk, whereby a color toner image is formed. The resulting color toner image is transferred onto transfer medium P in secondary transfer member 14b, and the resulting transfer media P is separated from intermediate belt 14a, followed by fixing in fixing device 17 and discharge from discharge outlet 18 to the exterior of the apparatus.

### EXAMPLES

The invention is illustrated in terms of Examples.

Toner of the invention was manufactured in the following manner.

Manufacture of Toner 1

Manufacture of Resin Particles A

### First Step Polymerization

In a reaction vessel equipped with a stirrer, a temperature sensor, a condenser and a nitrogen gas introducing device, a solution of 8 mass parts of sodium dodecylsulfate dissolved in 3,000 mass parts of ion-exchange water was charged and the internal temperature was raised to 80° C., while stirring at a stirring speed of 230 rpm under a nitrogen gas stream. After heating to the said temperature, a solution of 10 mass parts of potassium persulfate dissolved in 200 mass parts of ion-exchange water was added, then, the liquid temperature was raised again to 80 ° C., and a polymerizable monomer liquid described below was dropwise added thereto over a period of 1 hour. After completion of addition, the reaction mixture was heated at 80° C. for 2 hours while stirring to perform polymerization to prepare resin particles. This is referred to Resin Particles (1H).

### Monomer Mixture Liquid

| | |
|---|---|
| styrene | 480 parts by mass |
| n-butylacrylate | 250 parts by mass |
| methacrylic acid | 68.0 parts by mass |
| n-octyl-3-mercaptopropionate | 16.0 parts by mass |

### Second Step Polymerization

The monomer mixture liquid described below was heated with stirring up to 90° C., 190 parts by mass of polyethylene wax was dissolved in the monomer mixture liquid, Wax Containing Monomer Mixture Liquid was prepared.

### Monomer Mixture Liquid

| | |
|---|---|
| styrene | 245 parts by mass |
| n-butylacrylate | 120 parts by mass |
| n-octylmercaptan | 1.5 parts by mass |

In a reaction vessel equipped with a stirrer, a temperature sensor, a condenser and a nitrogen gas introducing device, a solution of 7 mass parts of sodium polyoxyethylene-2-dodecyl ether sulfate dissolved in 800 mass parts of ion-exchange water was charged. After the internal temperature was raised to 98° C., a polymerizable monomer solution in which 260 mass parts of the Resin Particles (1H) and Wax Containing Monomer Mixture Liquid, and mixed with stirring for 1 hour using a mechanical stirring machine having a circulation route, namely CLEARMIX (produced by M Technique Co., Ltd.) to prepare a dispersion containing emulsified particles (oil droplets).

Subsequently, to this dispersion added was an initiator solution of 6 mass parts of potassium persulfate dissolved in 200 mass parts of ion-exchange water and this system was heated at 82° C. while stirring over 1 hour to perform polymerization, whereby dispersion of resin particles was obtained This was referred to Resin Particle dispersion (1HM).

### Third Step Polymerization

To the foregoing resin particle dispersion (1HM) added was a solution of 11 mass parts of potassium persulfate dissolved in 400 mass parts of ion-exchange water, and Monomer Mixture Liquid described below was dropwise added over a period of 1 hour at 82° C. After completion of dropwise addition, the reaction mixture was cooled to 28 ° C. to obtain dispersion of resin particles. This was referred to Resin Particle Dispersion A. The Resin Particle Dispersion A was measured by a dynamic light scattering particle-size analyzer (MICROTRAC UPA 150, produced by Nikkiso Co., Ltd.) and the volume average particle size of the coloring agent particles was 200 nm.

### Monomer Mixture Liquid

| | |
|---|---|
| styrene | 435 parts by mass |
| n-butylacrylate | 130 parts by mass |
| methacrylic acid | 33 parts by mass |
| n-octyl-3-mercaptopropionate | 8 parts by mass |

### Manufacture of Resin Particles B

In a reaction vessel equipped with a stirrer, a temperature sensor, a condenser and a nitrogen gas introducing device, 2.3 parts by mass of sodium dodecylsulfate and 3000 parts by mass of ion-exchanged water were charged, and the internal temperature was raised to 80° C., while stirring at a stirring speed of 230 rpm under a nitrogen gas stream. After heating the temperature, a solution of 10 mass parts of potassium persulfate dissolved in 200 mass parts of ion-exchange water was added, then, the liquid temperature was raised again to 80° C., and a polymerizable monomer liquid described below was dropwise added thereto over a period of 1 hour. After completion of addition, the reaction mixture was heated at 80° C. for 2 hours while stirring to perform polymerization to prepare resin particles. This is referred to Resin Particles B. The Resin Particle Dispersion A was measured by a dynamic light scattering particle-size analyzer (MICROTRAC UPA 150, produced by Nikkiso Co., Ltd.) and the volume average particle size of the coloring agent particles was 70 nm.

### Monomer Mixture Liquid

| | |
|---|---|
| styrene | 520 parts by mass |
| n-butylaerylate | 210 parts by mass |
| methacrylic acid | 68.0 parts by mass |
| n-octyl-3-mercaptopropionate | 16.0 parts by mass |

### Preparation of Coloring Agent Dispersion Liquid

An anionic surfactant sodium dodecylsulfate in an amount of 59 parts by mass was dissolved by stirring in ion-exchanged water 1,600 parts by mass. While stirring the liquid, 420 parts by mass of coloring agent carbon black MOGUL L (Product by Cabot Corp.) was added gradually, subsequently the liquid was subjected to dispersion treatment by employing a dispersion device SCMILL (Product by Mitsui Mining Co., Ltd.), and Coloring Agent Dispersion Liquid was prepared. The Coloring Agent Dispersion Liquid was measured by a dynamic light scattering particle-size analyzer (MICROTRAC UPA 150, produced by Nikkiso Co., Ltd.) and the volume average particle size of the coloring agent particles was 150 nm.

Coagulation and Ripening

In a reaction vessel equipped with a stirrer, a temperature sensor, a condenser and a nitrogen gas introducing device, Resin Particle Dispersion A in amount of 300 parts by mass converted solid substance, 1,400 parts by mass ion-exchanged water, 120 parts by mass of Coloring Agent Dispersion Liquid and a solution of 3 parts by mass sodium polyoxyethylene-2-dodecyl ether sulfate dissolved in 120 parts by mass of ion-exchanged water were charged, after adjusting temperature at 30° C., 5N sodium hydroxide aqueous solution was added to so that pH became 10. Subsequently, aqueous solution of 35 parts by mass magnesium chloride dissolved in 35 parts by mass ion-exchanged water was added with stirring over 10 minutes at 30° C. After keeping 3 minutes, heating was started, heated up to 90° C. taking 60 minutes, and particle growing reaction was continued keeping at 90° C. Particle diameter of the coagulated particles was measured via MULTISIXER 3 in this state, 260 parts by mass of Resin Particles B was added at a time that volume based median diameter (D₅₀) reached 3.1 μm, and further particle growing reaction was continued. When D₅₀ reached to 6.5 μm, aqueous solution dissolving 150 parts by mass of sodium chloride dissolved in 600 parts by mass ion-exchanged water to terminate particle growing reaction, and further, stirring at keeping 98 ° C. as a ripening step to progress fusion of coagulated particles until circularity reached to 0.965 measured by FPIA-2100. Thereafter, the liquid was cooled to 30° C., stirring was terminated, and Liquid dispersion of toner mother particles was prepared.

(Supplying Na Atoms and Washing Step)
1. The toner mother particles were separated from liquid dispersion of toner mother particles cooled to 30° C. in the previous step by solid liquid separation, and the separated toner cake (gathered substance coagulating toner mother particles in a wet state to cake like shape) was prepared.
2. The toner cake in an amount of 100 parts by mass was dispersed again in 1,000 parts by mass of ion-exchanged water at 40° C., re-dispersed liquid was prepared by stirring for 10 minutes. The re-dispersed liquid had pH of 6.8.
3. To the re-dispersed liquid 25% by mass of NaOH aqueous solution was added to adjust pH to 13, it was stirred for 5 minutes.
4. To the pH-adjusted re-dispersed liquid NaCl in amount of 1/100 times of solid substance of the toner mother particles was added, and it was stirred for 5 minutes, whereby Na atoms were supplied.
5. Toner cake was prepared again by solid liquid separation of re-dispersed liquid.
6. The toner cake was washed by pouring ion-exchanged water at 40° C., until electric conductivity of the filtrate reached 10 μS/cm.
7. Washing-completed toner cake was prepared by solid liquid separation again after washing

(Drying Step)

Toner Mother Particles were prepared by drying washing-completed toner cake so that water content reached 0.5% by mass.

(External Additive Treatment Step)

Toner 1 was prepared by adding 1% by mass of hydrophobic silica (number average primary particle diameter of 12 nm) and 0.3% by mass of hydrophobic titania (number average primary particle diameter of=20 nm) to the toner mother particles obtained by the previous steps and blending by Henschel mixer.

(Manufacture of Toners 2 to 5)

Toners 2 to 5 were manufactured in the same mariner as manufacture of Toner 1 except that the pH adjusting method in the Supplying Na atoms, pH and amount of NaCl after the pH adjustment and washing step were modified as shown in Table 1.

(Manufacture of Toner 6)

Toner 6 was manufactured in the same manner as manufacture of Toner 1 except that the Supplying Na atoms and washing step was changed described below.

(Supplying Na Atoms and Washing Step)
1. The toner mother particles were separated from liquid dispersion of toner mother particles cooled to 30° C. in the previous step by solid liquid separation, and the separated toner cake (gathered substance coagulating toner mother particles in a wet state to cake like shape) was prepared.
2. The toner cake in an amount of 100 parts by mass was dispersed again in 1,000 parts by mass of ion-exchanged water at 40° C., re-dispersed liquid was prepared by stirring for 10 minutes. The re-dispersed liquid had pH of 6.8.
3. To the re-dispersed liquid 2.5% by mass of HCl aqueous solution was added to adjust pH to 5, it was stirred for 5 minutes.
4. To the pH-adjusted re-dispersed liquid NaCl in amount of 1/1,000 times of solid substance of the toner mother particles was added, and it was stirred for 5 minutes, whereby Na atoms were supplied.
5. Toner cake was prepared again by solid liquid separation of re-dispersed liquid.
6. The toner cake was washed by pouring ion-exchanged water at 40° C., until electric conductivity of the filtrate reached 10 μS/cm.
7. Washing-completed toner cake was prepared by solid liquid separation again after washing.

(Manufacture of Toner 7)

Toner 7 was manufactured in the same manner as manufacture of Toner 6 except that the pH adjusting method in the Supplying Na atoms, pH and amount of NaCl after the pH adjustment and washing step were modified as shown in Table 1

(Manufacture of Toner 8)

Toner 8 was manufactured in the same manner as manufacture of Toner 6 except that the Supplying Na atoms and washing step was changed described below.

(Supplying Na Atoms and Washing Step)
1. The toner mother particles were separated from liquid dispersion of toner mother particles cooled to 30° C. in the previous step by solid liquid separation, and the separated toner cake (gathered substance coagulating toner mother particles in a wet state to cake like shape) was prepared.
2. The toner cake in an amount of 100 parts by mass was dispersed again in 1,000 parts by mass of ion-exchanged water at 40° C., re-dispersed liquid was prepared by stirring for 10 minutes. The re-dispersed liquid had pH of 6.8.
3. To the re-dispersed liquid 2.5% by mass of HCl aqueous solution was added to adjust pH to 5, it was stirred for 5 minutes.
4. Toner cake was prepared again by solid liquid separation of the re-dispersed liquid.
5. The toner cake was washed by pouring ion-exchanged water at 40° C., until electric conductivity of the filtrate reached 10 μS/cm.
6. Washing-completed toner cake was prepared by solid liquid separation again after washing.

(Manufacture of Toner 9)

Toner 9 was manufactured in the same manner as manufacture of Toner 8 except that the pH adjusting method in the Supplying Na atoms, pH and amount of NaCl after the pH adjustment and washing step were modified as shown in Table 1

(Manufacture of Toner 10)

Toner 10 was manufactured in the same manner as manufacture of Toner 1 except that the Supplying Na atoms and washing step was changed described below.

(Supplying Na Atoms and Washing Step)
1. The toner mother particles were separated from liquid dispersion of toner mother particles cooled to 30° C. in the previous step by solid liquid separation, and the separated toner cake (gathered substance coagulating toner mother particles in a wet state to cake like shape) was prepared.
2. The toner cake in an amount of 100 parts by mass was dispersed again in 1,000 parts by mass of ion-exchanged water at 70° C., re-dispersed liquid was prepared by stirring for 10 minutes. The re-dispersed liquid had pH of 6.8.
3. To the re-dispersed liquid 25% by mass of NaOH aqueous solution was added to adjust pH to 10, it was stirred for 60 minutes.
4. Subsequently, the toner mother particles liquid dispersion of toner mother particles were subjected to solid liquid separation, the separated toner cake was washed with 500 parts by mass of ion-exchanged water at 40° C.
5. Hundred parts by mass of the toner cake was put in 1,000 parts by mass of ion-exchanged water at 40° C., and re-dispersed liquid was prepared by stirring for 10 minutes.
6. To the re-dispersed liquid 2.5% by mass of HCl aqueous solution was added to adjust pH to 5, it was stirred for 5 minutes.
7. Toner cake was prepared again by solid liquid separation of the re-dispersed liquid.
8. The toner cake was washed by pouring ion-exchanged water at 40° C., until electric conductivity of the filtrate reached 10 μS/cm.
9. Washing-completed toner cake was prepared by solid liquid separation again after washing.

A method of pH adjustment in the Supplying Na atoms and washing step, pH after adjustment, adding amount of NaOH, mass of Na atoms in the neighborhood of surface of the toner particles and mass of Na atoms contained in toner particles are shown in Table 1.

TABLE 1

| | Supplying Na Atoms and Washing Step | | | | | | |
|---|---|---|---|---|---|---|---|
| | | | | Adding | Mass of Na atoms in the | | |
| | | | | amount of | neighborhood of surface of the | Mass of Na atoms in toner | |
| Toner | pH adjustment | pH after | | NaOH | toner particles | particles | |
| No. | method | adjustment | | (times by mass) | (μg in 1 g of toner particles) | (μg in 1 g of toner particles) | |
| Toner 1 | Adding NaOH | 13 | | 1/100 | 750 | 1500 | Invention |
| Toner 2 | Adding NaOH | 13 | | 1/1,000 | 650 | 1300 | Invention |
| Toner 3 | Adding NaOH | 12 | | 1/1,000 | 450 | 1000 | Invention |
| Toner 4 | Adding NaOH | 11 | | 1/1,000 | 200 | 800 | Invention |
| Toner 5 | Adding NaOH | 8 | | 1/1,000 | 100 | 700 | Invention |
| Toner 6 | Adding HCl | 5 | | 1/1,000 | 40 | 600 | Comparative |
| Toner 7 | Adding HCl | 3 | | 1/1,000 | 30 | 600 | Comparative |
| Toner 8 | Adding HCl | 5 | | — | 12 | 550 | Comparative |
| Toner 9 | Adding HCl | 3 | | — | 10 | 550 | Comparative |
| Toner 10 | Adding NaOH(*) | 10 | (*) | — | 1,500 | 2,000 | Comparative |
| | Adding HCl(**) | 5 | (**) | | | | |

(*) First time
(**) Second time

The mass of Na atoms in the neighborhood of surface of the toner particles, and mass of Na atoms in the toner particles via Induction Coupling Plasma Optical Emission Spectrometer were measured by above described methods.

(Preparation of Developer)

Ferrite carrier covered with silicone resin having volume average particle diameter of 40 μm was added to each Toners 1 to 10 prepared above via V-type mixer, and Developers 1 to 10 having toner content of 6% were prepared .

Evaluation of Printing Practice

The developers prepared above were charged in a digital color multi-function printer bizhub PRO C6500 (product by Konica Minolta Business technologies Inc.) available in the market in sequence, and evaluation was conducted.

<Charge Quantity>

The developers 1 to 10 prepared above were left to stand at high temperature and high moisture (30° C., 80% RH) for 10 hours, charge quantity was measured by an electrolytic parting method described below. Charge quantity of 30 to 60 μC/g is acceptable.

(Measurement of Charge Quantity by Electrolytic Parting Method)

Charge quantity is measured by electrolytic parting method in the following steps.
(1) Thirty grams of developer prepared as above is put into 50 ml plastic bottle, and the plastic bottle is rotated at 120 rpm for 20 minutes.
(2) From the plastic bottle 1 g of developer is set on a magnet roller, and counter-electrodes, mass of which is preliminarily measured, is also set.
(3) Bias of 1 kV of same polarity as Toner is applied, and the magnet roller is rotated at 500 rpm for 1 minute in this state.
(4) After completion of rotation of the magnet roller, potential and mass between counter-electrodes, mass M(g) of toner attached to the counter-electrodes, Toner charge quantity Q/M (μC/g) is calculated by product Q of capacity of capacitor (set as 1 μF) and potential V between counter-electrodes.

<Image Density>

Image density was evaluated by that solid image of 10 cm square was printed at the initial stage and after 10,000 printing of character image of printing ratio of 5% in an environment of high temperature and high moisture (30° C., 80% RH), and image density was measured via a reflective densitometer RD-918 (product by Gretag Macbeth GMB) at 10 portion at random, and their average density was ranked. The image density of 1.40 or higher and difference of image density between initial print and 10,000th print of not more than 0.10 was ranked as acceptable.

<Sandy Image>

The sandy image was evaluated by that Test Chart No. 3, Sample No. 5-1 (color continuous portrait and color gradation batch) issued by the First Group of the imaging society of Japan was printed after 10,000 printing of character image of printing ratio of 5% in an environment of high temperature and high moisture (30° C., 80% RH),and evaluated. The sandy image ranked A and B are acceptable.

Evaluation Criteria

A: Sandy image is not felt in middle tone image by visual observation, and toner particles causing dust is not found by observing between dots via 20 times magnifier.

B: Sandy image is slightly felt in middle tone image by careful visual observation. Or 1 to 3 toner particles causing dust is found by observing between dots via 20 times magnifier.

C: Roughness is felt in middle tone image by visual observation in comparison with image of Rank B. Or countless toner particles causing dust is found by observing between dots via 20 times magnifier.

<Toner Scattering Inside of Printer>

In an environmental of high temperature and high moisture (30° C., 80% RH), after printing 10,000 sheets of white paper, scattering degree of inside of the printer was evaluated by visual observation. Toner scattering inside of printer ranked A or B is acceptable.

Evaluation Criteria

A: Almost no stain by toner inside of printer is observed.

B: Slight stain by toner inside of printer is observed.

C: A plenty of stain by toner inside of printer is observed.

The result is summarized in Table 2.

TABLE 2

| | | Image density | | | | | |
|---|---|---|---|---|---|---|---|
| | Charge | | After | | | | |
| | Quantity | Initial | 10,000 | Difference of | Sandy | Toner | |
| Toner (No.) | (μC/g) | print | prints | density | image | scattering | Remarks |
| Toner 1 | 60 | 1.44 | 1.41 | 0.03 | B | A | Invention |
| Toner 2 | 50 | 1.42 | 1.40 | 0.02 | A | A | Invention |
| Toner 3 | 45 | 1.42 | 1.40 | 0.02 | A | A | Invention |
| Toner 4 | 40 | 1.42 | 1.39 | 0.03 | A | A | Invention |
| Toner 5 | 35 | 1.42 | 1.38 | 0.04 | B | A | Invention |
| Toner 6 | 25 | 1.41 | 1.58 | 0.17 | C | C | Comparative |
| Toner 7 | 22 | 1.42 | 1.56 | 0.14 | C | C | Comparative |
| Toner 8 | 20 | 1.44 | 1.63 | 0.19 | C | C | Comparative |
| Toner 9 | 19 | 1.42 | 1.61 | 0.19 | C | C | Comparative |
| Toner 10 | 25 | 1.41 | 1.61 | 0.20 | C | C | Comparative |

It is confirmed as shown in Table 2, samples of the invention Toner 1 to 5 exhibit high charge quantity in an environment of high temperature and high moisture, printed matter having high image density is obtained even after 10,000 printing, a sandy image is not observed and toner scattering inside printer is not observed, and the advantage of the invention is attained. To the contrary, Comparative Toners 7 to 10 have problems in any one of the evaluation items and advantage of the invention is not attained.

1. A toner for developing an electrostatic latent image composed of toner particles which comprises toner mother particles containing a binding resin having a hydrophilic polar group, a coloring agent and a releasing agent, and an external additive, wherein a mass of Na atoms in a neighborhood of surface of the toner particles measured by the measuring method described below is 50 to 750 μg in 1 g of the toner particles,
Measuring Method
(a) Extracting Na atoms in the neighborhood of surface of the toner particles by stirring the toner particles and dilute hydrochloric acid,
(b) Preparing sample for measurement by filtering the liquid extracting Na atoms, and
(c) Measuring the mass of Na atoms in the sample via Induction Coupling Plasma Optical Emission Spectrometer.

2. The toner of claim 1, wherein the mass of Na atoms in a neighborhood of surface of the toner particles measured by the measuring method is 200 to 650 μg in 1 g of the toner particles.

3. The toner of claim 1, wherein the hydrophilic polar group is a carboxyl group.

4. The toner of claim 3, wherein the binding resin is composed of 3 to 25 mass % by mass of a polymerizable monomer having a hydrophilic polar group based on total polymerizable monomers composing the binding resin.

5. The toner of claim 4, wherein the binding resin is composed of 10 to 20 mass % by mass of a polymerizable monomer having a hydrophilic polar group based on total polymerizable monomers composing the binding resin.
